(19) United States
(12) Patent Application Publication
(10) Pub. No.: US 2006/0167997 A1
(43) Pub. Date: Jul. 27, 2006

(54) System, method and computer program product for establishing a conference session and synchronously rendering content during the same

(75) Inventor: Antti Forstadius, Espoo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/044,846

(22) Filed: Jan. 27, 2005

(51) Int. Cl. G06F 15/16

(52) U.S. Cl. 709/204

(57) ABSTRACT

A system for establishing and effectuating a conference session includes a plurality of participants. In turn, the participants include a source capable of operating in a fixed network environment, and at least one destination capable of operating in a cellular network environment. The participants are capable of establishing a conference session where one of the participants is a host and the other participants are members. During the conference session, then, the host is capable of sharing content with the members by reformatting content rendered for a local display into a vectorized format, and reformatting at least one update to the rendered content into a vectorized format. The host can transfer the reformatted content and reformatted update(s) to the members, which are then capable of rendering the respective reformatted content and reformatted update(s) in a manner at least partially in synch with the host rendering of the respective content and update(s).

### FIELD OF THE INVENTION

The present invention generally relates to systems and methods of providing content to a terminal and, more particularly, relates to systems and methods of providing content displayed by a source to a terminal having a limited display area, and for directing the presentation of the content at the terminal in substantially real time.

### BACKGROUND OF THE INVENTION

Today's business environment is increasingly dependent on information sharing as the basis for planning and decision making. Although communication can be solely verbal, its efficiency increases significantly when other modes of communication, such as visual information, are used concurrently. Visual information can be effectively used to augment verbal information and to improve the clarity and structure of the verbal communication. In the corporate environment, communication is extensively based on augmenting verbal/textual communication with visual information, e.g., in the form of e-mail attachments, printed matter and PowerPoint® presentations. Also, application sharing and workspace sharing (e.g., Microsoft Messenger®, Netmeeting®, Opentext OpenView®, etc.) are widely used in desktop conferencing for sharing material between participants.

Although images, data or other value-added information can be readily shared on computers within the corporate network, this information is generally not accessible to users who are out of the office or do not have access to their personal computers. Typically, when an employee is away from the office, he can still communicate verbally using his mobile phone, but he cannot share any visual information with the calling party, which could otherwise be used to augment the voice call and add value to the conversation. Accessing such material would generally require the user to first connect to the corporate network or mail server with his laptop to retrieve and view the material. This is very impractical, however, since it would require the person to have a personal computer and wireless/wireline access to a data network, and further require him to set up the computer, log into the network and finally find and download the relevant material typically over a low bandwidth connection.

If the user has a mobile terminal such as a “smartphone” or a Communicator-type of device, the device can also be used to access additional data over e-mail in e-mail attachments. However, downloading e-mail attachments can be time consuming and expensive, since normal application files—such as PowerPoint® files, images, etc.—are not optimized for mobile delivery and use, and therefore can be relatively large, thus resulting in long download times. Viewing e-mail attachments also requires that the user's mobile terminal be equipped with suitable viewing applications, which support the received application data type and version.

As can be seen from the foregoing, the present solutions for augmenting voice calls with images, data or other value added information, disadvantageously involve many pre-requisites—such as having a laptop, modem access or pre-installed viewing applications—and many phases for setting up a data connection and downloading the information. For these reasons, mobile users unfortunately have had to rely on using voice communication only or, alternatively, have had to go through the extensive and time consuming process of downloading material using a modem and laptop.

Further, images, data or other value added information are often created for rendering on a target platform, the target platform often having reasonable storage capacity, memory, bandwidth, and a large (typically at least 14-inch diagonal) display. Thus, since mobile terminals may have limited display area, resolution, and rendering capabilities, the mobile terminal may be unable to render such content as originally designed, or the mobile terminal may render the content in an extremely slow and/or inconvenient manner. Internet-enabled mobile phones, for instance, typically can display only a few lines of text, while their ability to render images may be confined to grayscale or thumbnail-sized images, or no images at all. An extreme example of a display-constrained medium is voice. In this regard, systems, such as AT&T Natural Voices™ Text-to-Speech Engine, allow users to access electronic documents by telephone, by dialing in to a service that uses text-to-speech conversion to dictate the contents of the documents over the phone. Dictation is necessarily a one-dimensional “rendering” of text, however, and cannot express the complex layout information embedded in a two-dimensional table.

Conventionally, devices that are unable to render such documents as they were originally designed due to limited screen size, resolution, and rendering capabilities take liberties when called upon to render such documents. In this regard, many Internet-enabled mobile devices restrict the maximum size of a document that they can render. For instance, most Internet-enabled phones that comply with the WAP (Wireless Application Protocol) standard only support documents less than or equal to 2000 bytes. Even for those mobile devices (e.g., Pocket PC's and palm-based computers) that do not impose a strict size limit on documents, large source documents are typically broken into smaller parts because transmitting long documents at once over slow wireless networks can try the patience of users.

### SUMMARY OF THE INVENTION

In light of the foregoing background, embodiments of the present invention provide an improved system, method and computer program product for establishing and effectuating a conference session between a number of participants, such as one or more personal computers (PCs) operating in a fixed network environment, and one or more mobile terminals operating in a cellular network environment. During the conference session, then, a host of the conference can share content with the members, where the content comprises that rendered for a local display of the host. To account for different displays of the members, the host can reformat the shared content into a vectorized format, such as by means of a virtual display driver. The reformatted content can then be provided to the other conference participants (referred to herein as “members”) such that the members can render the reformatted content for display.

According to one aspect of the present invention, a system is provided for establishing and effectuating a conference session, where the system includes a plurality of participants. In turn, the participants include a source capable of operating in a fixed network environment, and at least one destination capable of operating in a cellular network environment. The participants are capable of establishing a conference session where one of the participants is a host and the other participants are members. During the conference session, then, the host is capable of sharing content with the members at least partially in real time. In this regard, the host can reformat content rendered for a local display into a vectorized format, and can also reformat at least one update to the rendered content into a vectorized format. The host can transfer the reformatted content and reformatted update(s) to the members. The members are then capable of rendering the respective reformatted content and reformatted update(s) in a manner at least partially in synch with the host rendering of the content and update(s).

More particularly, the host can include a display driver and a display adapter to which content is capable of being directed. The display driver and display adapter can then be capable of interpreting and reformatting content and update(s) to the content to thereby render the respective content and update(s) for display. In addition, the host can include a virtual display driver to which the content and update(s) are also capable of being directed. In this regard, the virtual display driver can be capable of reformatting the content and update(s) at approximately the same time as the display driver and display adapter render the respective content and update(s) for display. To transfer the reformatted content and reformatted update(s), the host can further include a network adapter to which the virtual display driver can pass the reformatted content and reformatted updates. The network adapter, then, can transfer the respective reformatted content and reformatted update(s) to the members.

To more efficiently share content between the host and members, the members can receive the reformatted content, generate a dynamic model of the reformatted content, and there after render the dynamic object model to there by render the reformatted content. For the reformatted update(s), then, the members can receive the reformatted update(s) and update the dynamic object model based upon the update(s). The members can then render the updated dynamic object model to there by render the reformatted update(s).

In addition to transferring reformatted content and reformatted update(s), the host can also be capable of generating and transferring one or more control events to direct the rendering of the reformatted content and/or update(s). The members, then, can process the control event by altering the rendering of the respective reformatted and/or update(s) for display by the respective members.

A source, terminal, method and computer program product for establishing and effectuating a conference session are also provided. Embodiments of the present invention therefore provide a system, method and computer program product for establishing and effectuating a conference session with a plurality of participants. In accordance with embodiments of the present invention, a host of the conference session (e.g., the source) is capable of sharing content with the members, where the shared content comprises content rendered for a local display of the host, and updates to the rendered content. The host reformats the content and updates into a vectorized format by means of a virtual display driver at the host. The reformatted content and reformatted updates can then be transferred to the other participants of the conference session, such that those participants can likewise render the content. In this regard, by reformatting the content and updates into a vectorized format, the content and updates can more readily be rendered by devices for which the content may not have been intended, such as mobile terminals. As such, the system, method and computer program product of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of one type of terminal and system that would benefit from embodiments of the present invention;

FIG. 2 is a schematic block diagram of an entity capable of operating as a terminal, computing system and/or conferencing server, in accordance with embodiments of the present invention;

FIG. 3 is a schematic block diagram of a terminal comprising a mobile station, in accordance with one embodiment of the present invention;

FIG. 4 is a functional block diagram of a source transferring content to a destination via a messaging gateway, and thereafter participating in a conference including rendering of the content, in accordance with one embodiment of the present invention;

FIG. 5 is a schematic architecture diagram that functionally illustrates a source client operating above an operating system platform with other software and hardware to perform at least a portion of one embodiment of the present invention;

FIGS. 6a and 6b are flowcharts illustrating various steps in a method of transferring content from a source to one or more destinations, and at least partially controlling the rendering of such content at the source and/or destination(s), in accordance with one embodiment of the present invention; and

FIGS. 7, 8 and 9 illustrate exemplar displays presented by a host, source and a conference member, destination during a conference session, in accordance with one embodiment of the present invention.

### DETAILED DESCRIPTION OF THE INVENTION

The present invention now will be described more fully here in after with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

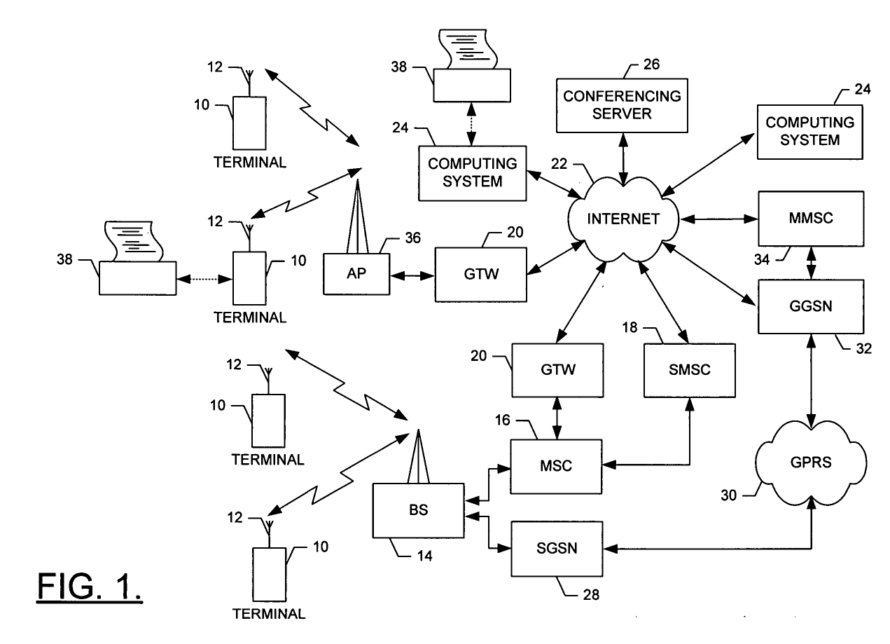

Referring to FIG. 1, an illustration of one type of terminal and system that would benefit from the present invention is provided. The system, method and computer program product of embodiments of the present invention will be primarily described in conjunction with mobile communications applications. It should be understood, however, that the system, method and computer program product of embodiments of the present invention can be utilized in conjunction with a variety of other applications, both in the mobile communications industries and outside of the mobile communications industries. For example, the system, method and computer program product of embodiments of the present invention can be utilized in conjunction with wireline and/or wireless network (e.g., Internet) applications.

As shown, one or more terminals 10 may each include an antenna 12 for transmitting signals to and for receiving signals from a base site or base station (BS) 14. The base station is a part of one or more cellular or mobile networks that each include elements required to operate the network, such as a mobile switching center (MSC) 16. As well known to those skilled in the art, the mobile network may also be referred to as a Base Station/MSC/Interworking function (BMI). In operation, the MSC is capable of routing calls to and from the terminal when the terminal is making and receiving calls. The MSC can also provide a connection to landline trunks when the terminal is involved in a call. In addition, the MSC can be capable of controlling the forwarding of messages to and from the terminal, and can also control the forwarding of messages for the terminal to and from a messaging center, such as short messaging service (SMS) messages to and from a SMS center (SMSC) 18.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a GTW 20, and the GTW is coupled to a WAN, such as the Internet 22. In turn, devices such as processing elements (e.g., personal computers, server computers or the like) can be coupled to the terminal 10 via the Internet. For example, as explained below, the processing elements can include one or more processing elements associated with a computing system 24 (two shown in FIG. 1), conferencing server 26 (one shown in FIG. 1) or the like, as described below.

The BS 14 can also be coupled to a signaling GPRS (General Packet Radio Service) support node (SGSN) 28. As known to those skilled in the art, the SGSN is typically capable of performing functions similar to the MSC 16 for packet switched services. The SGSN, like the MSC, can be coupled to a data network, such as the Internet 22. The SGSN can be directly coupled to the data network. In a more typical embodiment, however, the SGSN is coupled to a packet-switched core network, such as a GPRS core network 30. The packet-switched core network is then coupled to another GTW, such as a GTW GPRS support node (GGSN) 32, and the GGSN is coupled to the Internet. In addition to the GGSN, the packet-switched core network can also be coupled to a GTW 20. Also, the GGSN can be coupled to a messaging center, such as a multimedia messaging service (MMS) center 34. In this regard, the GGSN and the SGSN, like the MSC, can be capable of controlling the forwarding of messages, such as MMS messages. The GGSN and SGSN can also be capable of controlling the forwarding of messages for the terminal to and from the messaging center.

In addition, by coupling the SGSN 28 to the GPRS core network 30 and the GGSN 32, devices such as a computing system 24 and/or conferencing server 26 can be coupled to the terminal 10 via the Internet 22, SGSN and GGSN. In this regard, devices such as a computing system and/or conferencing server can communicate with the terminal across the SGSN, GPRS and GGSN. By directly or indirectly connecting the terminals and the other devices (e.g., computing system, conferencing server, etc.) to the Internet, the terminals can communicate with the other devices and with one another, such as according to the Hypertext Transfer Protocol (HTTP), to there by carry out various functions of the terminal.

Although not every element of every possible mobile network is shown and described herein, it should be appreciated that the terminal 1O can be coupled to one or more of any of a number of different networks through the BS 14. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The terminal 10 can further be coupled to one or more wireless access points (APs) 36. The APs can comprise access points configured to communicate with the terminal in accordance with techniques such as, for example, radio frequency (RF), Bluetooth (BT), infrared (IrDA) or any of a number of different wireless networking techniques, including WLAN techniques. The APs 36 may be coupled to the Internet 22. Like with the MSC 16, the APs can be directly coupled to the Internet. In one embodiment, however, the APs are indirectly coupled to the Internet via a GTW 20. As will be appreciated, by directly or indirectly connecting the terminals and the computing system 24, conferencing server 26, and/or any of a number of other devices, to the Internet, the terminals can communicate with one another, the computing system, etc., to there by carry out various functions of the terminal, such as to transmit data, content or the like to, and/or receive content, data or the like from, the computing system. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 1, in addition to or in lieu of coupling the terminal 10 to computing systems 24 across the Internet 22, the terminal and computing system can be coupled to one another and communicate in accordance with, for example, RF, BT, IrDA or any of a number of different wireline or wireless communication techniques, including LAN and/or WLAN techniques. One or more of the computing systems can additionally, or alternatively, include a removable memory capable of storing content, which can there after be transferred to the terminal. Further, the terminal 10, computing system and/or conferencing server 26 can be coupled to one or more electronic devices 38, such as printers, digital projectors and/or other multimedia capturing, producing and/or storing devices (e.g., other terminals). Like with the computing systems, the terminal can be configured to communicate with the portable electronic devices in accordance with techniques such as, for example, RF, BT, IrDA or any of a number of different wireline or wireless communication techniques, including USB, LAN and/or WLAN techniques.

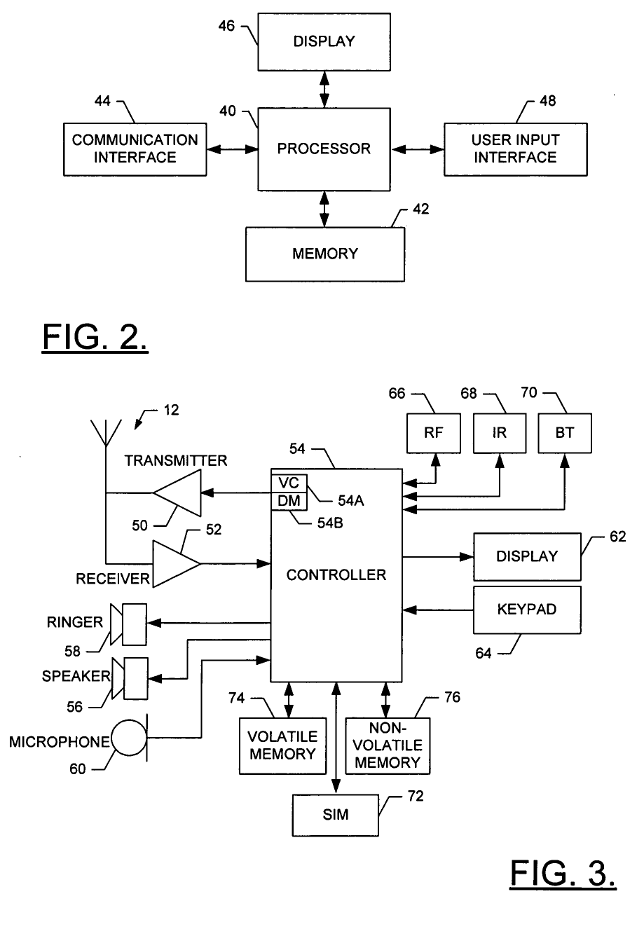

Referring now to FIG. 2, a block diagram of an entity capable of operating as a terminal 10, computing system 24 and/or conferencing server 26, is shown in accordance with one embodiment of the present invention. Although shown as separate entities, in some embodiments, one or more entities may support one or more of a terminal, conferencing server and/or computing system, logically separated but co-located within the entit(ies). For example, a single entity may support a logically separate, but co-located, computing system and conferencing server. Also, for example, a single entity may support a logically separate, but co-located terminal and computing system. Further, for example, a single entity may support a logically separate, but co-located terminal and conferencing server.

As shown, the entity capable of operating as a terminal 10, computing system 24 and/or conferencing server 26 can generally include a processor 40 connected to a memory 42. The memory can comprise volatile and/or non-volatile memory, and typically stores content, data or the like. For example, the memory typically stores content transmitted from, and/or received by, the entity. Also for example, the memory typically stores software applications, instructions or the like for the processor to perform steps associated with operation of the entity in accordance with embodiments of the present invention.

In addition to the memory 42, the processor 40 can also be connected to at least one interface or other means for displaying, transmitting and/or receiving data, content or the like. In this regard, the interface(s) can include at least one communication interface 44 or other means for transmitting and/or receiving data, content or the like, as well as at least one user interface that can include a display 46 and/or a user input interface 48. The user input interface, in turn, can comprise any of a number of devices allowing the entity to receive data from a user, such as a keypad, a touch display, a joystick or other input device.

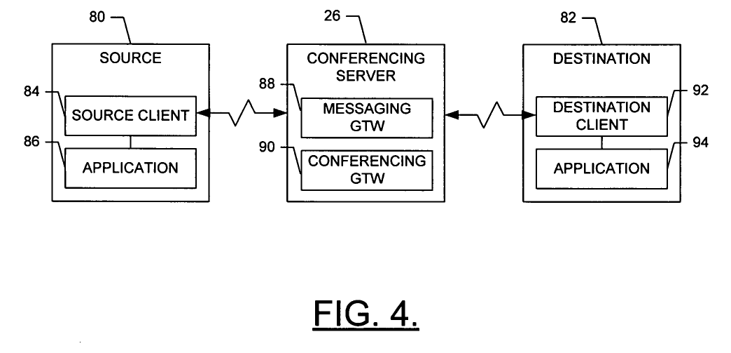

Reference is now made to FIG. 3, which illustrates one type of terminal 10 that would benefit from embodiments of the present invention. It should be understood, however, that the terminal illustrated and here in after described is merely illustrative of one type of terminal that would benefit from the present invention and, therefore, should not be taken to limit the scope of the present invention. While several embodiments of the terminal are illustrated and will be hereinafter described for purposes of example, other types of terminals, such as portable digital assistants (PDAs), pagers, laptop computers and other types of electronic systems, can readily employ the present invention.

As shown, in addition to an antenna 12, the terminal 10 includes a transmitter 50, a receiver 52, and a controller 54 that provides signals to and receives signals from the transmitter and receiver, respectively. These signals include signaling information in accordance with the air interface standard of the applicable cellular system, and also user speech and/or user generated data. In this regard, the terminal can be capable of operating with one or more air interface standards, communication protocols, modulation types, and access types. More particularly, the terminal can be capable of operating in accordance with any of a number of first generation (1G), second generation (2G), 2.5G and/or third-generation (3G) communication protocols or the like. For example, the terminal may be capable of operating in accordance with 2G wireless communication protocols IS-136 (TDMA), GSM, and IS-95 (CDMA). Also, for example, the terminal may be capable of operating in accordance with 2.5G wireless communication protocols GPRS, Enhanced Data GSM Environment (EDGE), or the like. Further, for example, the terminal may be capable of operating in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, mobile terminals may also benefit from the teaching of this invention, as should dual or higher mode phones (e.g., digital/analog or TDMA/CDMA/analog phones).

It is understood that the controller 54 includes the circuitry required for implementing the audio and logic functions of the terminal 10. For example, the controller may be comprised of a digital signal processor device, a microprocessor device, and various analog-to-digital converters, digital-to-analog converters, and other support circuits. The control and signal processing functions of the terminal are allocated between these devices according to their respective capabilities. The controller can additionally include an internal voice coder (VC) 54A, and may include an internal data modem (DM) 54B. Further, the controller may include the functionally to operate one or more software programs, which may be stored in memory (described below). For example, the controller may be capable of operating a connectivity program, such as a conventional Web browser. The connectivity program may then allow the terminal to transmit and receive Web content, such as according to HTTP and/or the Wireless Application Protocol (WAP), for example.

The terminal 10 also comprises a user interface including a conventional earphone or speaker 56, a ringer 58, a microphone 60, a display 62, and a user input interface, all of which are coupled to the controller 54. The user input interface, which allows the terminal to receive data, can comprise any of a number of devices allowing the terminal to receive data, such as a keypad 64, a touch display (not shown) or other input device. In embodiments including a keypad, the keypad includes the conventional numeric (0-9) and related keys (#, *), and other keys used for operating the terminal. Although not shown, the terminal can include a battery, such as a vibrating battery pack, for powering the various circuits that are required to operate the terminal, as well as optionally providing mechanical vibration as a detectable output.

The terminal 10 can also include one or more means for sharing and/or obtaining data. For example, the terminal can include a short-range radio frequency (RF) transceiver or interrogator 66 so that data can be shared with and/or obtained from electronic devices in accordance with RF techniques. The terminal can additionally, or alternatively, include other short-range transceivers, such as, for example an infrared (IR) transceiver 68, and/or a Bluetooth (BT) transceiver 70 operating using Bluetooth brand wireless technology developed by the Bluetooth Special Interest Group. The terminal can therefore additionally or alternatively be capable of transmitting data to and/or receiving data from electronic devices in accordance with such techniques. Although not shown, the terminal can additionally or alternatively be capable of transmitting and/or receiving data from electronic devices according to a number of different wireless networking techniques, including WLAN techniques such as IEEE 802.11 techniques or the like.

The terminal 10 can further include memory, such as a subscriber identity module (SIM) 72, a removable user identity module (R-UIM) or the like, which typically stores information elements related to a mobile subscriber. In addition to the SIM, the terminal can include other removable and/or fixed memory. In this regard, the terminal can include volatile memory 74, such as volatile Random Access Memory (RAM) including a cache area for the temporary storage of data. The terminal can also include other non-volatile memory 76, which can be embedded and/or may be removable. The non-volatile memory can additionally or alternatively comprise an EEPROM, flash memory or the like. The memories can store any of a number of pieces of information, and data, used by the terminal to implement the functions of the terminal. For example, the memories can store an identifier, such as an international mobile equipment identification (IMEI) code, international mobile subscriber identification (IMSI) code, mobile station integrated services digital network (MSISDN) code (mobile telephone number), Session Initiation Protocol (SIP) address or the like, capable of uniquely identifying the mobile station, such as to the MSC 16. As explained below, the memories can also store one or more applications capable of operating on the terminal.

As explained in the background section, in various instances a user may desire to access or otherwise view a document through a medium for which the document was not originally designed. For example, a user may desire to view a document through a terminal 10 that may have limited display area, resolution, and rendering capabilities and may be unable to render such documents as they were originally designed, or they may render them in an extremely slow and/or inconvenient manner. And as will be appreciated, in various instances users may desire to engage in a conference in which the content sent by a source device and received by one or more destination devices is used to augment a verbal communication between the respective users.

Therefore, in accordance with embodiments of the present invention, a conference session can be established between a source (e.g., personal computer) capable of operating in a fixed network environment (e.g., LAN, MAN, WAN, etc.), and one or more destinations (e.g., personal computers, terminals, etc.) capable of operating in the fixed network environment or a cellular network environment (e.g., TDMA, GSM, CDMA, GPRS, EDGE, MBMS, DVB, CSD, HSCSD, etc.). During the conference session, then, content rendered for display by a host (e.g., source or destination) can be transferred to the conference members for rendering by the conference members in a manner substantially in synch with the host. In various instances, however, one or more of the conference members may not be capable of rendering the content in the same manner as the host. As such, the host is capable of reformatting the content into a scalable representation in substantially real time with display of the content by the host, such as by means of a virtual display interface at the source, before providing the content to the conference member(s). The scalable representation can then be provided to the destination(s).

In accordance with embodiments of the present invention, the conference session and/or transfer of content can be directly effectuated between the source and destination(s). Additionally or alternatively, one or both of the conference session and transfer of content can be indirectly effectuated by means of a conferencing server 26 that is capable of interfacing between the fixed network environment and the cellular network environment for those destination(s) operating in the cellular network. Irrespective of how the conference member(s) receive the scalable representations of the content displayed by the host, the conference member(s) can there after render the content (or scalable representation of the content), such as by a display (e.g., display 62).

Also during the conference session, the source can generate control events that direct rendering of the content sent by the source and received by the destination(s). The source can then transfer those control events to the destination(s), directly or indirectly via the conferencing server. Accordingly, the destination(s) can render the content in accordance with the source's control events. The source can thereby direct rendering of the content locally at the source, and can also at least partially direct rendering of the content remotely at the destination(s).

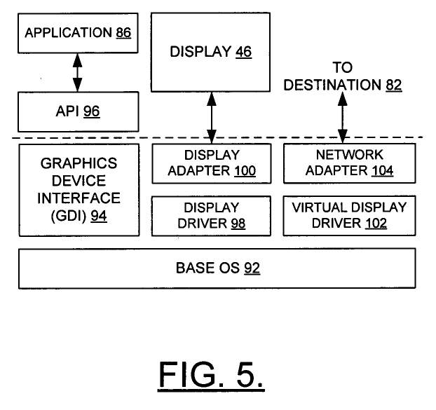

Reference is now drawn to FIG. 4, which illustrates a functional block diagram of a source 80 of content providing or otherwise transferring one or more pieces of content to one or more destinations 82 (one being shown) and participating in a conference including rendering of the content where, of the conference participants, the source is capable of operating in a fixed network environment and the destinations are capable of operating in the fixed network environment and/or a cellular network environment. As shown, the source is capable of operating one or more source applications 86, such as content viewers and/or editors. The content can comprise any of a number of different types of content including, for example, presentation slides, spreadsheets, clipboard data, images in various graphics formats (e.g., JPG, GIF, BMP, etc.), screenshots, documents and the like. Thus, the content viewer and/or editor can comprise any of a number of different applications capable of rendering the content for display by the source.

To permit the source 80 to transfer content to the destination 82 in accordance with embodiments of the present invention, the source is also capable of operating a source client 84. The source client of one embodiment includes or is otherwise in communication with a virtual display driver, such as a Microsoft® Windows® mirror driver configured in accordance with embodiments of the present invention. In such an embodiment, the source client is capable of interfacing with the display functionality of the source presenting, for display, content accessed by a content viewer and/or editor application 86 operating on the source. Briefly, the source client 84 of the source 80 is capable of interfacing with the display functionality of the source to there by reformat content accessed by the application 86 and presented for display by the source, where the content is reformatted into a vectorized format such as by implementing or otherwise communicating with a graphics filter. The source client can reformat the content into any of a number of different vectorized formats. In one typical embodiment, for example, the source client can reformat the content into a SVG (scalable vector graphics) format or any derivatives of the like (e.g., Mobile SVG, SVG-Tiny, SVG-Basic, etc.).

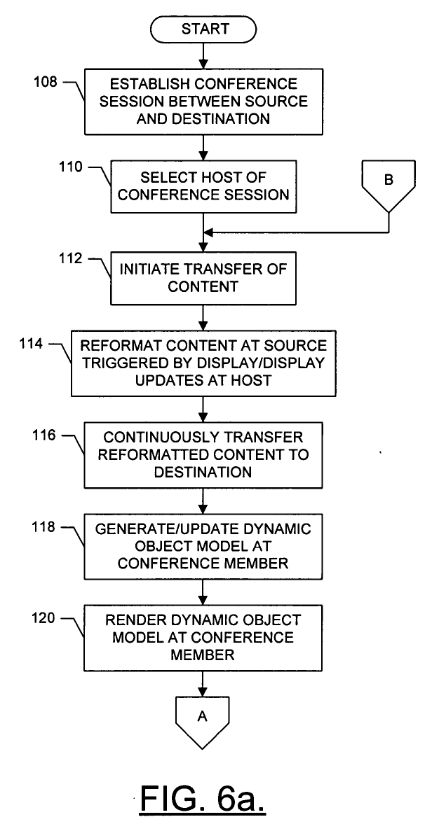

Reference is now made to FIG. 5, which illustrates an architecture diagram of the source 80 of one embodiment of the present invention, where the source applications 86 operate on top of an operating system (OS) platform, such as Microsoft® Windows®. As explained below, reference will be made to the source operating in accordance with the Microsoft® Windows® platform, although it should be understood that the source can be configured to operate in accordance with any of a number of other platforms. For example, in lieu of the Microsoft® Windows® platform, applications may operate on top of operating systems such as Linux, Apple® Mac OS® or the like.

Generally, the architecture of the source 80 is a common core of application programming interfaces (APIs) and operating system technology. It contains all of the interfaces to user interface (UI) applications, dynamic link libraries (DLLs), executables (EXEs) and device drivers for controlling various hardware devices of the source including, for example, the communication interface 44, display 46 and user input interface 48 (see FIG. 2). More particularly, as shown, the architecture of the source can include the base OS 92 that provides the programming framework for the other components of the architecture. Operating above the base OS, the architecture includes a graphics device interface (GDI) 94 that provides functions and related structures utilized by applications 86 to generate graphical output for rendering devices such as the display, and/or other electronic devices (e.g., electronic devices 38) such as printers, digital projectors and/or other multimedia rendering devices coupled to the source.

To render graphic output from the applications 86, the GDI 94 interfaces with the applications by means of middleware APIs 96 for such services and components. In this regard, Microsoft® Windows® provides a UI API that interacts with the respective applications to generate graphical output for rendering devices (e.g., display 46). The graphical output is generally produced as drawing elements (e.g., shapes, vectors, bitmaps) and is directed to the GDI. In turn, the GDI re-directs the graphical output to a device driver and a device adapter (one of each being shown as a display driver 98 and a display adapter 100), which interpret and reformat the graphical output to the specific rendering device. In the case of output for the display, for example, the display driver passes the graphical output to a display adapter 100, card or the like, which rasterizes the content for the particular display. Similarly, in the case of output for a printer (i.e., electronic device 38), a printer driver can filter the graphical output, convert the filtered output into an appropriate graphics format (e.g., PostScript), and pass the converted output to a printer by means of an appropriate hardware interface.

As also shown in accordance with one embodiment of the present invention, the architecture of the system 80 further includes a source client 84 that, in turn, includes or is otherwise associated with a virtual display driver 102. The virtual display driver, is adapted to capture the same graphical output that is re-directed from the GDI 94 to the display driver 98. In turn, the virtual display driver is capable of dynamically reformatting the graphical output into a vectorized (e.g., SVG) format. The functionality of the virtual display driver is therefore similar to that of the display driver and display adapter 100 which receive, interpret and reformat graphical output for a particular display 46. In contrast to the display driver and display adapter, however, the virtual display driver does not rasterize the graphical output, but instead dynamically reformats the graphical output into a vectorized format. In this regard, the virtual display driver can reformat the graphical output in a number of different manners, including in accordance with graphics encoding techniques utilizing the processor resources and software of the source 82, and/or utilizing hardware accelerators (as in a display adapter).

In addition to dynamically reformatting the content, the source client can request, and there after receive, an address or other identity of the destination such that the source can establish a conference session with one or more destinations based upon respective addresses. Alternatively, the conference session can be established by means of peer-to-peer communication whereby the conference session can be established by means of techniques such as SIP or some other technique for setting up a data connection between conference participants.

Irrespective of the means of establishing a conference session, after acquiring the appropriate parameters, the source 80 can communicate with the destination 82 can establish a conference session there between based upon such parameters. In accordance with the embodiment shown in FIG. 5, for example, a conference session can be established with a destination by means of network adapters 104, such as IP communications sockets, at the source and at the destination. Then, after reformatting the graphical output, the virtual display driver can pass the vectorized graphical output to the network adapter of the source which, in turn, can transfer the vectorized graphical output to the network adapter of the destination.

In lieu of directly establishing a conference session with a destination 82, the source can indirectly establish the conference session via a conferencing server 26, as shown in FIG. 4. More particularly, for example, the source can establish a communication session with a conferencing server interfacing between the source and destination. The source can then transfer the destination address to the conferencing server such that the conferencing server can establish a communication session with the conferencing server, and thus the conference session between the source and destination via the conferencing server. In this regard, the conferencing server 26 can include a messaging gateway (GTW) 88 and a conferencing gateway (GTW) 90. Then, upon receipt of the destination address or other identity of the destination, the conferencing gateway 90 can establish a conference session between the source 80 and the destination 82. Alternatively, the conferencing gateway can provide a conference ID to the source and one or more destinations 82 such that the source and destination(s) can there after establish communication sessions with the conferencing server, and establish a conference session there between utilizing the conference ID.

Generally, the conferencing server 26 handles control, during a conference between the source 80 and destination 82, of a conference host directing the rendering of the content by the other participants of the conference (i.e., conference members). In addition, the conferencing server can handle post-processing of the content from the source, and delivery of the content to the destination. If so desired, the conferencing server can also perform tasks related to user/client authentication, user registration, user account management, transaction logging and billing/collection of source user transaction data. It is also possible to use a web server in the conferencing server for distributing the source client 84 to the source (and a destination client 92 to the destination), and for providing tools for user registration and setting up user accounts. As described herein, the source and conferencing server comprise separate entities. It should be understood, however, that a single entity may support a logically separate, but co-located, source and conferencing server, without departing from the spirit and scope of the present invention.

After the conference session is established between the source 80 and destination 82, a host for the conference session can be selected from the conference participants, with the other conference participants being referred to as conference members. In one typical instance explained herein, for example, the source is selected as the host while the destination operates as a conference member. After the conference session has been established and the host has been selected, the host (e.g., source) can reformat and transfer reformatted content (vectorized graphical output), where the host is triggered by rendering such content for a local display. During the conference session, then, updates in the content rendered for display by the host can trigger the reformatting and transfer of content reflective of such updates, where the reformatted content can be transferred directly to the conference members or indirectly to the conference members via to the conferencing server.

Irrespective of exactly how the conference member (e.g., destination 82) receives the reformatted content (vectorized graphical output), the conference member is capable of operating a client (e.g., destination client 92) capable of receiving the reformatted content from the host (e.g., source 80), directly or indirectly via the conferencing server 26. Upon receiving the reformatted content, the conference member client can be capable of generating a dynamic object model of the reformatted content, and rendering the dynamic object model for display by the conference member. Alternatively, as shown, the conference member client can be capable of communicating with one or more applications (e.g., destination applications 94), such as content viewers and/or editors, capable of rendering the dynamic object model for display by the conference member. Then, as updates in the content rendered for display by the host are reformatted and transferred to the conference member during the conference session, the conference member can update the dynamic object model based upon the updates, and correspondingly update the rendered dynamic object model displayed by the conference member.

Also during the conference session, the host (e.g., source 80) can at least partially direct the rendering of the content. When effectuating the conference session by means of the conferencing server 26, for example, the host client (e.g., source client 84) can send the conferencing gateway 90 one or more control events that direct the rendering, or some aspect of the rendering, of the content. The conferencing gateway can then transfer those control events to the clients of the members of the conference session (e.g., destination client 92). Upon receipt of the control events, the clients of the conference members can render the content in accordance with the control events.

As shown and described herein, the source application 86 and source client 84, the messaging gateway 88 and conferencing gateway 90, and the destination client 92 and destination application 94 each comprise software operated by the source 80, conferencing server 26 and destination 82, respectively. It should be understood, however, that the source application, source client, messaging gateway, conferencing gateway, destination client and/or destination application can alternatively comprise firmware or hardware, without departing from the spirit and scope of the present invention. Also, although the source application and source client, the messaging gateway and conferencing gateway, and the destination client and destination application are shown and described as being local to the source, conferencing server and destination, respectively, any one or more of the source application and source client, the messaging gateway and conferencing gateway, and the destination client and destination application can alternatively be distributed from, and in communication with, the source, conferencing server and destination, respectively, such as across the Internet 22. Further, as shown and described herein, content is provided or otherwise transferred from a source to a destination. It should be understood, however, that the terms “providing” and “transferring” can be used herein interchangeably, and that providing or transferring content can include, for example, moving or copying content, without departing from the spirit and scope of the present invention.

The system, method and computer program product of embodiments of the present invention will now be described in more detail with respect to a source 80 establishing a conference session with one or more destinations 82, and effectuating the conference session between the source and destination. As described herein, a source can comprise any entity (e.g., terminal 10, computing system 24, etc.) functioning in accordance with embodiments of the present invention to transfer one or more pieces of content to one or more destinations. The destination, on the other hand, can comprise any entity (e.g., terminal, computing system, etc.) functioning in accordance with embodiments of the present invention to receive content from the source and there after render the content for display, if so desired. As will be further appreciated, although functionally operating in different manners, the same entity can, at different times, function as a source, destination or both a source and a destination.

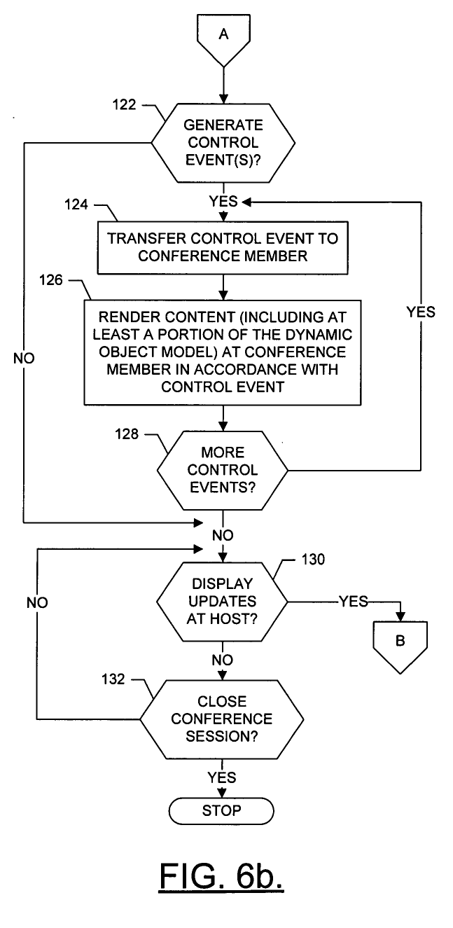

Reference is now drawn to FIGS. 6a and 6b, which illustrate a flowchart including various steps in a method of establishing and effectuating a conference session between a source 80 and one or more destinations 82, where effectuating the conference session includes continuous online transferring and, if so desired, at least partially controlling the rendering of content. As shown and described herein with respect to the flowchart of FIGS. 6a and 6b, the conference session is established and effectuated between the source and destination(s) independent of a conferencing server 26. It should be understood, however, that the conference session can be established, and/or the content and/or rendering control, can alternatively be transferred by means of a conferencing server, such as in the manner explained above. For more information on a technique of establishing and effectuating a conference session by means of a conferencing server, see U.S. patent application Ser. No. 10/978,861, entitled: System, Method and Computer Program Product for Providing Content to a Terminal and Directing the Rendering of Such Content in the Terminal, filed Nov. 1, 2004, the contents of which are hereby incorporated by reference in its entirety.

As shown in block 108 of FIG. 6a, the illustrated method of one embodiment of the present invention includes establishing a conference session between the source 80 and one or more destinations 82. As will be appreciated, the conference session can be established in any of a number of different manners including, for example, by initiating the source client 84 to establish a conference session with the destination. More particularly, for example, in some applications the installation of the source client can cause macro command buttons to be embedded into the application's menu bar, which can directly activate the conference establishment process. For example, the source client installation can create a command button named “Establish Conference” into Microsoft® Office applications (e.g., Word, PowerPoint®, etc.) in a “Conferencing” menu, which can thereafter be used to initiate the source client.

After initiating the source client 84, the source client can request, and there after receive from a source user, an address (e.g. MSISDN, SIP address, etc.) of the destination 82, as well as any of a number of other pieces of information that may or may not be necessary to establish a data connection between the source 80 and destination, if so desired. For example, the source client can present, on the source display 46, a dialog box requesting the MSISDN of a destination comprising a terminal 10. In addition, the dialog box can receive a text message that can be transferred to the destination along with a request to enter into a conference session with the source. As will be appreciated, the destination address can be received in any of a number of different manners. For example, the destination address can be received manually, such as from a source user via a user input interface of the source. Alternatively, the destination address can be selected from a directory (e.g., contacts directory) based upon a user of the destination, for example, where the directory is stored or otherwise accessible by the source.

If so desired, the source client 84 can also request, and receive, one or more configuration parameters to there by permit a source user to configure the source client. For example, the source client can request, and receive, configuration parameters including an identity or other information relating to the source user, such as the name, phone number and/or e-mail address of the user (one or more identities of the source being referred to as “source user information”). Also for example, when the conference session is established and effectuated by means of a conferencing server 26, the configuration parameters can include an address, and any other locators, parameters and the like of the conferencing server (e.g., IP address, port number, communication protocol, servlet path, user ID/password to access the conferencing server, etc.). In addition, if the source communicates with the conferencing server via a proxy server, such as in instances where firewall restrictions require the user to communicate via a proxy server (not shown), the configuration parameters can include an address, and any other locators, parameters and the like of the proxy server (e.g., IP address, port number, user ID/password to access the proxy server, etc.). As will be appreciated, although the source client can receive configuration parameters each time the source client is initiated to establish a conference session, the source client more typically receives configuration parameters before the first instance of establishing a conference session with the destination, and there after uses the same configuration parameters (unless altered by the source user) to establish subsequent conference sessions.

After receiving the destination 82 address and any other information, the source client 84 can establish a conference session with the destination based upon the destination address and other received information. In this regard, the source client can establish a conference session with the destination, or more particularly the destination client 92 in accordance with the communication protocol specified in the configuration parameters. The conference session can be established in accordance with any of a number of different transfer techniques, including any of a number of different cellular (e.g., 1G, 2G, 2.5G, 3G, etc.) communication techniques such as IS-136 (TDMA), GSM, IS-95 (CDMA), GPRS, EDGE, MBMS, DVB (e.g., DVB-T, DVB-H, etc.), CSD (Circuit Switched Data), HSCSD (High-Speed CSD), any of a number of different short range communication techniques such as RF, BT, IRDA, and/or any of a number of different wireless and/or wireline networking techniques such as LAN and/or WLAN techniques. If so desired, the conference session can be established in accordance with a secure technique, such as SSL (secure sockets layer). Thereafter, the source can transfer the request to enter the source in a conference session with the destination, where the request may include the identity or other information relating to the source or source user, as previously specified in the configuration parameters. Then, presuming the destination, destination client and/or destination user accepts the request to enter the source in a conference session, the conference session is there by established such that the source and destination can communicate with one another across the conference session.

Before or after the conference session is established between the source 80 and the destination 82, a host for the conference session can be selected from among the conference participants, the other conference participant being referred to as a conference member, as shown in block 110. The host can be selected in any of a number of different manners. For example, the source can be selected as the host by default when the source requests to enter into a conference session with the destination. Alternatively, for example, the source or destination can be selected as the conference host after the conference session is established by one of the conference participants sending the other participant a request to operate as the conference host. As explained below for purposes of illustration, the source is selected as the host of the conference session, although it should be understood that the destination can alternatively be selected as the host.

Regardless of how the conference host is selected, the host client (e.g., source client 84) can be initiated to continuously transfer content to the conference member (e.g., destination 82), or more particularly the conference member client (e.g., destination client 92), as shown in block 112. The host client can be initiated to transfer content in any of a number of different manners, and at any instance during the conference session. For example, the source client can be initiated to transfer content by activating a “Synchronize Display” command button in the aforementioned “Conferencing” menu embedded into the menu bar of a host application (e.g., source application 86). In such instances, particularly when the host client includes or otherwise communicates with a virtual display driver 102, the content for transfer includes the content rendered by the host, under direction of the host application, for presentation by a host display (e.g., source display 46). In addition, the content can also include the graphical user interface (GUI) of the host application and/or any other graphical content rendered for display at the source, under the direction of one or more of any of a number of different applications.

After initiating the host client (e.g., source client 84) to transfer content, the host client dynamically and continuously reformats all or at least a portion of the content rendered for display by the host into a vectorized format, such as the SVG format, as shown in block 114. More particularly with reference to the source 82 shown in FIG. 5, for example, as the host application (e.g., source application 86) produces graphical output, the graphical output is directed to the GDI 94 by means of a middleware API (e.g., UI API) interfacing between the applicant and the GDI. To render the graphical output for presentation by the host display 46, the GDI re-directs the graphical output to a display driver 98 that interprets the graphical output, and passes the graphical output to a display adapter 100. To further transfer the displayed content to the conference member (e.g., destination 82), however, the GDI can also re-direct the graphical output to a virtual display driver 102, which dynamically and continuously reformats the graphical output into a vectorized format.

Irrespective of how the host client (e.g., source client 84) reformats the content, the source client thereafter transfers the reformatted content to the conference member (e.g., destination 82), or more particularly the conference member client (e.g., destination client 92), as shown in block 116. Before transferring the content to the conference member, however, the host client can, if so desired, compress the reformatted content, such as in accordance with the GNU zip technique. Again referring to the source 82 shown in FIG. 5, for example, after the virtual display driver 102 reformats the graphical output, the virtual display driver can pass the vectorized graphical output to a network adapter 104 (e.g., IP communications socket) of the host. The host network adapter, in turn, can transfer the vectorized graphical output to a network adapter of the conference member in a substantially real-time manner with rendering of the same output for display by the host.

After receiving the reformatted content, the conference member (e.g., destination 82) can utilize the content in any of a number of different manners. For example, the conference member client (e.g., destination client 92) and/or the conference member application (e.g., destination application 94) in communication with the conference member client can uncompress the content (if compressed), and render the content for presentation by a display 46 of the conference member. Before the content is rendered for display, however, the conference member client can generate and store in memory of the conference member (e.g., memory 42) a dynamic object model of the reformatted content, as shown in block 118. Then, in lieu of directly rendering the reformatted content, the conference member client and/or conference member application can be configured to render the dynamic object model for presentation by the display of the conference member, as shown in block 120.

At a number of different instances during the conference session between the host (e.g., source 80) and the conference member (e.g., destination 82), the host may transfer content to the conference member, such as in the same manner described above. In this regard, at one or more instances during the conference session, the host client (e.g., source client 84) can be initiated to transfer content to the conference member (e.g., destination 82), or more particularly the conference member client (e.g., destination client 92) (see block 112). Instead of actively initiating the host client to transfer content at each instance, however, the host client can be configured to automatically initiate the transfer of content at a number of regular or irregular intervals. For example, the host client can be configured to be continuously triggered to initiate the transfer of content as content rendered for display by the host is updated, as shown in block 130 of FIG. 6b. Alternatively, for example, the host client can be configured to automatically initiate the transfer of content with the same frequency that the host display 46 refreshes its presentation of graphical content. At each instance, then, the content transferred to the conference member can include, as before, the graphical content currently rendered for display at the host under the direction of one or more of any of a number of different host applications (e.g., source application 86). Thus, by triggering the host client to initiate the transfer of content as content rendered for display is updated or as the display otherwise refreshes its presentation of graphical content, the conference member can receive reformatted content including the updated or refreshed display such that the conference member displays the same content as the host.

As before, at each instance of the host client (e.g., source client 84) being initiated to transfer content, the source client can reformat the content into a vectorized format, such as the SVG format, and transfer the reformatted content to the conference member (e.g., destination 82), or more particularly the conference member client (e.g., destination client 92). As will be appreciated, however, it may be that only a portion of the graphical content currently rendered for display at the host, which is otherwise reformatted and transferred to the conference member, changes across a number of instances during the conference session. Thus, in lieu of reformatting and transferring the graphical content currently rendered for display at the host at each instance the host client is initiated to transfer such content, the host client may be configured to reformat and transfer portions of the graphical content currently rendered for display at the host necessary to update the dynamic object model to synchronize the display of the host with that of the conference member. Thus, upon receipt of subsequent content, the conference member client can update the dynamic object model based upon the received content (see block 118). The conference member client and/or conference member application can then render the updated dynamic object model for presentation by the display (e.g., display 46) of the conference member (see block 120).

As shown in blocks 122 and 124 of FIG. 6b, in addition to transferring reformatted content to the conference member (e.g., destination 82), the host client (e.g., source client 84) can, if so desired, generate and transfer one or more control events to the conference member client (e.g., destination client 92) during the conference session. Generally, the control events are generated based upon the content currently rendered for display at the host. More particularly, the control events can be generated to direct the conference member (e.g., destination 82) to render content, including at least a portion of the dynamic object model, for presentation by the display 46 of the conference member. In such instances, the control events are generated and transferred such that the members are capable of rendering the content, including at least a portion of the dynamic object model, based upon the control events in a manner at least partially in synch with the content rendered for presentation by the display of the host. The control events can be generated in any of a number of different manners, and comprise any of a number of different instructions that at least partially control the rendering of the content by the conference member.

For example, the control events can include portions of the graphical content currently rendered for display by the host (e.g., source 80) that are not included in the dynamic object model, or otherwise differ from corresponding portions of the dynamic object model. In such instances, the host client (e.g., source client 84) can reformat the portions of content in a manner explained above. Additionally or alternatively, the control events can include instructions directing the conference member (e.g., destination 82) as to the manner of rendering the reformatted portions of content included in the control events. Further, for example, the control events can include instructions directing the rendering of the dynamic object model itself, such as by scrolling within the content already being rendered by the conference member, move a cursor or other pointer relative to the rendered content, toggle between different view modes of rendered content, or the like, where the rendered content includes the dynamic object model whose rendering may have been updated by other control events.

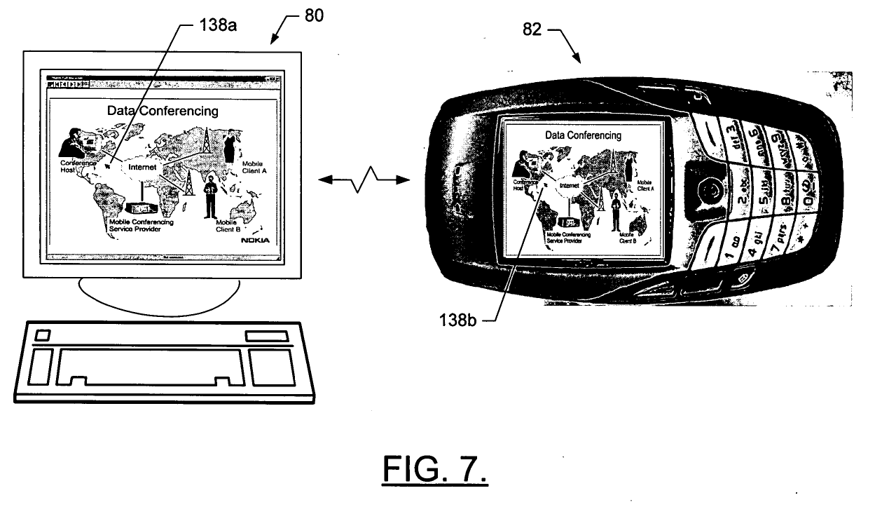

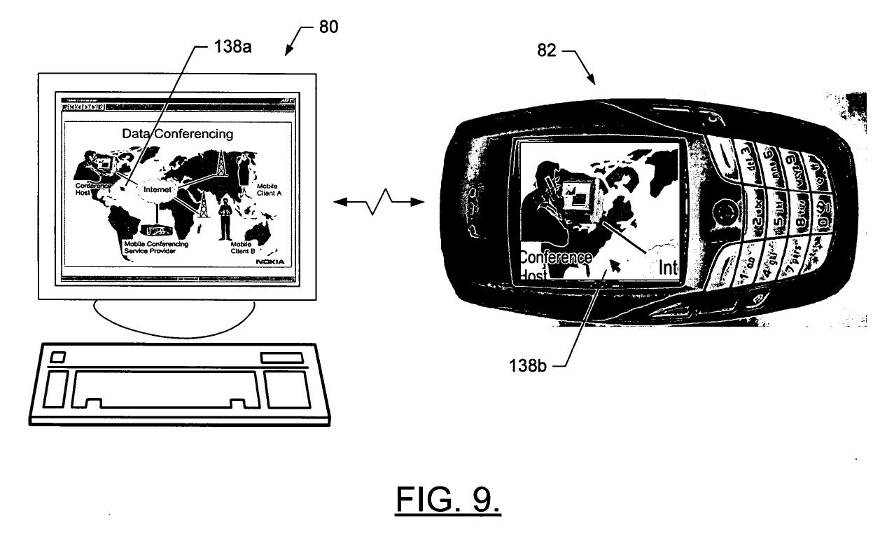

FIGS. 7-9, for example, consider a source 80 comprising a computing system 24 that is operating a source application 86, where the source is functioning as the host of a conference session with at least one conference member comprising destination 82 comprising a mobile terminal 10 operating a destination application 94. Over the course of the conference session, the host application (e.g., source application 86) can be directed, such as by a host user (e.g., source user), to modify or otherwise alter the rendering of the content at the host (e.g., source 80), or more particularly by the host application. For example, the source application can be directed to modify or otherwise alter the rendering of the content based upon input received by the source application from a source user via a user input interface of the source, such as by directing a cursor or other pointer relative to the rendered content to zoom, pan and/or scroll within a page of the rendered content. Irrespective of how the host application is directed to modify or otherwise alter the rendering of the content at the host, however, the source client can generate or otherwise select control events to represent the modifications made to the rendering of the content by the host application. And as explained below, the control events can be subsequently used to direct the conference member application to make the same modifications made by the host application such that the content, including at least a portion of the dynamic object models, rendered by the participants of the conference session may remain at least partially synchronized.

Thus, upon receipt of the control event, the conference member client (e.g., destination client 92), and/or a conference member application (e.g., destination application 94) in communication with the destination client, can render content, including at least a portion of the dynamic object model, in accordance with the control event, as shown in block 126. For example, when the control event includes instructions to scroll within content (including at least a portion of the dynamic object model) already being rendered by the conference member, move a cursor or other pointer relative to rendered content, or change the page of rendered content including multiple pages, the conference member client and/or conference member application can process the control event to accordingly effectuate the respective instructions.

When the control event includes instructions to move a cursor or other pointer, for example, the conference member client (e.g., destination client 92) and/or conference member application (e.g., destination application 94) can accordingly process the control event to move the pointer relative to the rendered content. As shown in FIG. 7, the host, source user can direct movement of a cursor or other pointer 138a relative to the content rendered by the host, source application 86, such as by means of a user input interface of the source. In response to movement of the pointer, the host, source client 84 can generate or otherwise select control events, and transfer those control events, such that a pointer 138b is similarly capable of being moved relative to content rendered by the conference member, destination application 90.

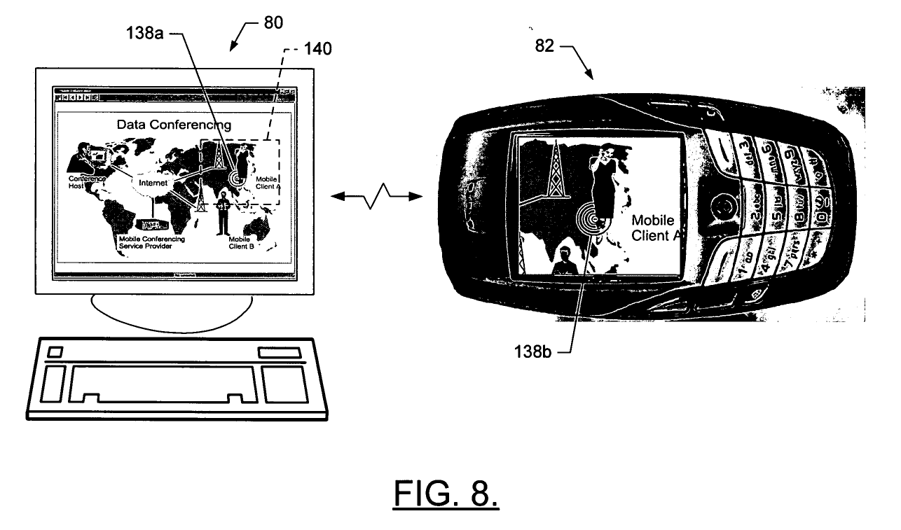

When the control event includes instructions to toggle to a zoom and/or pan view of rendered content, for example, the conference member client (e.g., destination client 92) and/or conference member application (e.g., destination application 94) can accordingly process the control event to zoom the rendered content by a specified factor, and/or pan within the rendered content. Again referring to the example shown in FIG. 7, the host, source user can again direct movement of a cursor or other pointer 138a relative to the content rendered by the host, source application 86, such as by means of a user input interface of the source, as shown in FIG. 8. The source user can then select a portion 140 of the rendered content, such as the portion about the pointer (selection of the portion being illustrated as a series of concentric circles), by means of the user input interface. Then, in response to the source user's selection of the portion of the rendered content, the host, source client 84 can generate or otherwise select control events for panning to that portion of the content selected by the source user. Thus, upon receipt of the respective control events, the conference member, destination application 90 is capable of accordingly panning to the portion of the similarly rendered content selected by the source user. In such an instance, a pointer 138b can be presented relative to the panned portion rendered by the destination application, such as in accordance with other control events processed by the destination application, as also shown in FIG. 8.

During the conference session between the host (e.g., source 80) and conference member (e.g., destination 82), the host client (e.g., source client 84) can send, and the conference member or, more particularly, a conference member client (e.g., destination client 92), can receive, additional control events, as shown in block 128. For each received control event, the conference member client, and/or a conference member application (e.g., destination application 94) in communication with the destination client, can render the content in accordance with the control event, as before. The conference session between the host and conference member can continue for a period of time after the last control event sent by the host client is received by the conference member, during which content rendered for display by the host can be reformatted and transferred to the conference member for rendering (see block 130). At some point after the last control event is processed by the conference member client and/or conference member application to render the content in accordance with the respective control event, the host and/or conference member may desire to end the conference session, as shown in block 132. At such an instance, then, the host and/or conference member can close the conference session. Closing the conference session, then, may close the communication sessions previously established between the host and the conferencing server, and the conferencing server and the destination.

As more particularly explained above, the conference session includes a conference host (e.g., source 80) and a single conference member (e.g., destination 82). It should be understood, however, that the conference session may, and often will, include a number of additional conference participants, typically additional destinations. In such instances, then, the conference session includes a host and a plurality of conference members. In one typical embodiment, for example, the host comprises a source 80 such as a computing system 24 in a fixed network environment. The conference members in the typical embodiment, then, comprise destinations 82, at least one of which is a terminal 10 in a cellular network environment. Also, one or more of the destinations may comprise other computing systems, also in the fixed network environment.

As will be appreciated, the host of the conference session may be selected at one or more times before and/or during the conference session. Thus, whereas the source 80 may initially be selected as the conference session host, at some point during the conference session, the host may be reselected to be a destination 82. At such an instance, then, a destination becomes the host and the source becomes the conference member, with control events being sent and received in the same manner between the host and the conference member, as explained above. Also during the conference session, the host can again be reselected to be another destination, or even to again be the source.

As also explained above, the conference host directs the rendering of the content at the conference members during the conference session. It should also be appreciated, however, that the conference members themselves may also at least partially control the local rendering of the content. Thus, the conference member client (e.g., destination client 92) and/or conference member application (e.g., destination application 94) can render, or be directed to render (e.g., by a conference member user), the content independent of a control event directing the rendering of the content. Likewise, the conference member client and/or conference member application can modify or otherwise alter the rendering of the content, or be directed to do the same, independent of a control event.

Again returning to the example of FIG. 7 for a moment, presume that the host, source application 86 is rendering a whole page view of rendered content, and that the host, source user is directing or has directed movement of a pointer 138a relative to the rendered content, as shown in FIG. 10. In such an instance, the conference member, destination application 94 is capable of similarly rendering the entire page of content, and a pointer 138b is similarly capable of being moved relative to content rendered by the conference member, destination application. Also in such an instance, the destination user can select a portion of the content rendered by the destination application, such as by means of the user input interface of the destination 82. By selecting a portion of the content, the destination user can direct the destination application to zoom and/or pan within the content rendered by the destination application, the destination application being directed independent of control events from the host, source application.

Further, as explained above, the source 80 and destination 82 can engage in a conference in which similar content is simultaneously rendered by both the source application 86 and the destination application 94, the source application rendering the content while the destination application renders the same content after reformatting by and receipt from the source. In this regard, the content can comprise display output generated by a source application 86, while the content rendered by the destination typically comprises reformatted display output generated by the source application. Thus, the source can more particularly control the rendering of the reformatted content at the destination by updating or otherwise changing the display output generated by the same or another source application, where those updates can be reflected at the destination in an at least partially automatic manner. Additionally, the source can control the rendering of the reformatted content by means of control events from source client that instruct the destination to reformat a particular area or scaling factor of the content already present at the destination).

To illustrate the benefits of embodiments of the present invention, consider the case of a “mobile meeting.” In such an instance, consider that a destination 82 comprises a mobile terminal 10 of a mobile user that is away from the user's office and needs to attend a business meeting occurring at the office. In order to fully participate in the business meeting, the mobile user needs to be able to share the same meeting material (i.e., content) as the other meeting attendees, who are present at the meeting. Thus, the mobile user asks the meeting organizer at the office to share the host display/application window with his mobile terminal. The meeting organizer, operating a personal computer (i.e., source 80) at the office, starts a presentation application (i.e., application 86) that renders the meeting material for display by the personal computer. Integral with, or separate from, the presentation application, the meeting organizer also starts a conferencing application (i.e., source client 84) to thereby establish a conference session with the mobile terminal of the mobile user.

After the conferencing application establishes the conference session, a UI API and GDI of the personal computer direct graphical output from the presentation application to a virtual display driver, the graphical output also being directed to a display of the personal computer. The virtual display driver, in turn, continuously reformats the graphical content, and passes the reformatted graphical content to a network adapter for transfer to the mobile terminal in real time. Thus, after receiving the reformatted meeting material, the meeting organizer can remotely cause the mobile terminal to render the meeting material for display by the mobile terminal, zoom in, pan, scroll and/or view the meeting material in detail, and in a manner simultaneously with the other meeting participants while participating in a conference call with the other meeting participants.

According to one aspect of the present invention, all or a portion of the system of the present invention, such all or portions of the conferencing server 26, source 80 and/or destination 82, generally operates under control of a computer program product (e.g., source application 86, source client 84, messaging gateway 88, conferencing gateway 90, the destination client 92, destination application 94, etc.). The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIGS. 6a and 6b are flowcharts of methods, systems and program products according to the invention. It will be understood that each block or step of the flowcharts, and combinations of blocks in the flowcharts, can be implemented by computer program instructions. These computer program instructions may be loaded onto a computer or other programmable apparatus to produce a machine, such that the instructions which execute on the computer or other programmable apparatus create means for implementing the functions specified in the flowcharts' block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts' block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowcharts' block(s) or step(s).

Accordingly, blocks or steps of the flowcharts support combinations of means for performing the specified functions, combinations of steps for performing the specified functions and program instruction means for performing the specified functions. It will also be understood that each block or step of the flowcharts, and combinations of blocks or steps in the flowcharts, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for establishing and effectuating a conference session, the system comprising a plurality of participants, the participants comprising:
a source capable of operating in a fixed network environment; and
at least one destination capable of operating in a cellular network environment,
wherein the participants are capable of establishing a conference session therebetween, wherein one of the participants is a host of the conference session and the other participants are members of the conference session,
wherein the host is capable of sharing content with the members at least partially in real time by reformatting content rendered for a local display into a vectorized format, reformatting at least one update to the rendered content into a vectorized format, and transferring the reformatted content and the at least one reformatted update to the members, and
wherein the members are capable of rendering the reformatted content and the at least one reformatted update in a manner at least partially in synch with the host rendering the respective content and the at least one update.

2. A system according to claim 1, wherein the host comprises a display driver and a display adapter to which content is capable of being directed such that the display driver and display adapter are capable of interpreting and reformatting content and at least one update to the content to there by render the respective content and at least one update for display,
wherein the host also comprises a virtual display driver to which the content and the at least one update is capable of being directed such that, at approximately the same time as the display driver and display adapter render the content and the at least one update for display, the virtual display driver is capable of reformatting the respective content and at least one update.

3. A system according to claim 2, wherein the host further comprises a network adapter, wherein the virtual display driver is capable of passing the reformatted content and the at least one reformatted update to a network adapter of the host such that the network adapter is thereafter capable of transferring the respective reformatted content and at least one reformatted update to the members.

4. A system according to claim 1, wherein the members are capable of receiving the reformatted content, generating a dynamic object model of the reformatted content, and rendering the dynamic object model to there by render the reformatted content, and
wherein the members are capable of receiving the at least one reformatted update, updating at least a portion of the dynamic object model based upon the at least one reformatted update, and rendering the updated dynamic object model to there by render the at least one reformatted update.

5. A system according to claim 1, wherein the host is capable of generating at least one control event to alter the rendering of at least one of the reformatted content and the at least one reformatted update, and
wherein the members are capable of processing the control event to alter the rendering of at least one of the reformatted content and the at least one reformatted update for display by the respective members.

6. A source capable of operating in a fixed network environment, the source comprising:
a display; and
a processor capable of operating a source client in a conference session between a plurality of participants, the participants including the source and at least one destination capable of operating in a cellular network environment, wherein the source is a host of the conference session and the other participants are members of the conference session,
wherein the source client is capable of sharing content with the members at least partially in real time by reformatting content rendered for a local display into a vectorized format, reformatting at least one update to the rendered content into a vectorized formation, and transferring the reformatted content and the at least one reformatted update to the members such that the members are capable of rendering the reformatted content and the at least one reformatted update in a manner at least partially in synch with the host rendering the respective content and the at least one update.

7. A source according to claim 6 further comprising:
a display driver and a display adapter to which the processor is capable of directing content such that the display driver and display adapter are capable of interpreting and reformatting content and at least one update to the content for the display,
wherein the source client comprises a virtual display driver to which the content and the at least one update is capable of being directed such that, at approximately the same time as the display driver and display adapter interpret and reformat the content and at least one update for display, the virtual display driver is capable of reformatting the respective content and at least one update.

8. A source according to claim 7 further comprising a network adapter, wherein the virtual display driver is capable of passing the reformatted content and the at least one reformatted update to the network adapter such that the network adapter is there after capable of transferring the respective reformatted content and at least one reformatted update to the members.

9. A source according to claim 6, wherein the source client is capable of transferring the reformatted content such that the members are capable of receiving the reformatted content, generating a dynamic object model of the reformatted content, and rendering the dynamic object model to thereby render the reformatted content, and
wherein the source client is capable of transferring the at least one reformatted update such that the members are capable of receiving the at least one reformatted update, updating at least a portion of the dynamic object model, and rendering the updated dynamic object model to there by render the at least one reformatted update.

10. A source according to claim 6, wherein the source client is capable of generating at least one control event to alter the rendering of at least one of the reformatted content and the at least one reformatted update, and wherein the source client is capable of transferring the control event such that the members are capable of processing the control event to alter the rendering of at least one of the reformatted content and the at least one reformatted update for display by the respective members.

11. A mobile terminal capable of operating in a cellular network environment, the mobile terminal comprising:
a processor capable of operating a client in a conference session between a plurality of participants, wherein the participants include a source operating in a fixed network environment, and include at least one destination, wherein at least one of the destinations comprises the mobile terminal, wherein one of the participants is a host of the conference session and the other participants are members of the conference session,
wherein the client is capable of receiving reformatted content and at least one reformatted update to the content from the host, the host having shared the content and at least one update with the members at least partially in real time by reformatting content rendered for a local display of the host into a vectorized format, reformatting at least one update to the rendered content into a vectorized format, and transferring the reformatted content and the at least one reformatted update to the members, and
wherein at least one of the client and another application operated by the processor is capable of rendering the reformatted content and the at least one reformatted update received by the client in a manner at least partially in synch with the host rendering the respective content and the at least one update.

12. A mobile terminal according to claim 11, wherein the client is capable of receiving reformatted content at least one reformatted update of the content from the host, the host having rendered the respective content and at least one update by directing content from an application to a display driver and a display adapter of the host, the display driver and display adapter being capable of interpreting and reformatting the respective content and at least one update for a display of the host, and at approximately the same time, by directing the respective content and at least one update to a virtual display driver of the host, the virtual display driver being capable of reformatting the respective content and at least one update.

13. A mobile terminal according to claim 12, wherein the client is capable of receiving reformatted content and at least one reformatted update from a network adapter of the host, the network adapter having been passed the respective reformatted content and reformatted at least one update from the virtual display driver.

14. A mobile terminal according to claim 11, wherein the client is capable of receiving the reformatted content and generating a dynamic object model of the reformatted content such that at least one of the client and another application operated by the processor is capable of rendering the dynamic object model to there by render the reformatted content, and
wherein the client is capable of receiving at least one reformatted update and updating at least a portion of the dynamic object model based upon the at least one reformatted update such that at least one of the client and another application operated by the processor is capable of rendering the updated dynamic object model to there by render the at least one reformatted update.

15. A mobile terminal according to claim 11, wherein the client is capable of receiving at least one control event to alter the rendering of at least one of the reformatted content and the at least one reformatted update, and
wherein the client is capable of processing the control event such that at least one of the client and the other application are capable of altering the rendering of at least one of the reformatted content and the at least one reformatted update for display.

16. A method of establishing and effectuating a conference session, the method comprising:
establishing a conference session between a plurality of participants, the participants including a source capable of operating in a fixed network environment and at least one destination capable of operating in a cellular network environment, wherein one of the participants is a host of the conference session and the other participants are members of the conference session; and
sharing content from the host with the members at least partially in real time, wherein sharing content comprises:
reformatting content rendered for a local display of the host into a vectorized format;
reformatting at least one update to the rendered content into a vectorized format; and
transferring the reformatted content and the at least one reformatted update to the members such that the members are capable of rendering the reformatted content in a manner at least partially in synch with the host rendering the respective content and the at least one update.

17. A method according to claim 16, wherein the host is capable of directing content from an application to a display driver and a display adapter of the host, the display driver and display adapter being capable of interpreting and reformatting content and at least one update to the content for a display of the host, wherein reformatting content rendered for a local display comprises directing the content to a virtual display driver of the host at approximately the same time as the content is directed to the display driver and display adapter, and
reformatting the content at the virtual display driver, and
wherein reformatting at least one update comprises directing the at least one update to the virtual display driver at approximately the same time as the at least one update is directed to the display driver and display adapter, and reformatting the at least one update at the virtual display driver.

18. A method according to claim 17, wherein transferring the reformatted content and the at least one reformatted update comprises passing the reformatted content and the at least one reformatted update to a network adapter of the host, the network adapter thereafter transferring the respective reformatted content and at least one reformatted update to the members.

19. A method according to claim 16, wherein transferring the reformatted content comprises transferring the reformatted content such that the members are there after capable of receiving the reformatted content, generating a dynamic object model of the reformatted content, and rendering the dynamic object model to there by render the reformatted content, and
wherein transferring the at least one reformatted update comprises transferring the at least one reformatted update such that the members are there after capable of receiving the at least one reformatted update, updating at least a portion of the dynamic object model based upon the at least one reformatted update, and rendering the updated dynamic object model to thereby render the at least one reformatted update.

20. A method according to claim 16 further comprising:
generating at least one control event to alter the rendering of at least one of the reformatted content and the at least one reformatted update; and
transferring the control event to the members such that the members are capable of processing the control event to alter the rendering of at least one of the reformatted content and the at least one reformatted update for display by the respective members.

21. A computer program product for establishing and effectuating a conference session, the computer program product comprising at least one computer-readable storage medium having computer-readable program code portions stored therein, the computer-readable program code portions comprising:
a first executable portion for establishing a conference session between a plurality of participants, the participants including a source capable of operating in a fixed network environment and at least one destination capable of operating in a cellular network environment, wherein one of the participants is a host of the conference session and the other participants are members of the conference session;
a second executable portion for sharing content from the host with the members at least partially in real time, wherein the second executable portion is adapted to share content by:
reformatting content rendered for a local display of the host into a vectorized format;
reformatting at least one update to the rendered content into a vectorized format; and
transferring the reformatted content and the at least one reformatted update to the members such that the members are capable of rendering the reformatted content in a manner at least partially in synch with the host rendering the respective content and the at least one update.

22. A computer program product according to claim 21, wherein the second executable portion comprises a virtual display driver, wherein the virtual display driver is adapted to receive the content and at least one update at approximately the same time as the respective content and at least one update is directed from an application to a display driver and a display adapter of the host, the display driver and display adapter being capable of interpreting and reformatting the respective content and at least one update for a display of the host.

23. A computer program product according to claim 22, wherein the second executable portion is adapted to transfer the reformatted content and the at least one reformatted update by means of a network adapter of the host, the network adapter being passed the respective reformatted content and at least one reformatted update from the virtual display driver.

24. A computer program product according to claim 21, wherein the second executable portion is adapted to transfer the reformatted content such that the members are there after capable of receiving the reformatted content, generating a dynamic object model of the reformatted content, and rendering the dynamic object model to thereby render the reformatted content, and
wherein the second executable portion is adapted to transfer the at least one reformatted update such that the members are thereafter capable of receiving the at least one reformatted update, updating at least a portion of the dynamic object model based upon the at least one reformatted update, and rendering the updated dynamic object model to thereby render the at least one reformatted update.

25. A computer program product according to claim 21 further comprising:
a third executable portion for generating at least one control event to alter the rendering of at least one of the reformatted content and the at least one reformatted update; and
a fourth executable portion for transferring the control event to the members such that the members are capable of processing the control event to alter the rendering of at least one of the reformatted content and the at least one reformatted update for display by the respective members.
